(19) United States
(12) Patent Application Publication
(10) Pub. No.: US 2026/0191227 A1
(43) Pub. Date: Jul. 9, 2026

(54) OILSEED CAKES PROTEIN EXTRACTION COMPOSITION

(71) Applicant: DOW GLOBAL TECHNOLOGIES LLC, Midland, MI (US)

(72) Inventor: Hema Sagar Giddi, Navi Mumbai (IN)

(21) Appl. No.: 19/132,901

(22) PCT Filed: Nov. 13, 2023
(86) PCT No.: PCT/US2023/079487

§ 371 Date: May 27, 2025

(30) Foreign Application Priority Data
Dec. 8, 2022 (IN) 202241070877

(51) Int. Cl. A23J 1/14

(52) U.S. Cl. CPC A23J 1/14

(57) ABSTRACT

A protein extraction composition includes water, oilseed cake, wherein a weight ratio of the water to oilseed cake is 10:1 or less, an alkali salt, and a surfactant, wherein the surfactant is selected from the group consisting of an ionic surfactant, a non-ionic surfactant, and combinations thereof.

### BACKGROUND

### Field of the Disclosure

The present disclosure is directed to an extraction composition, and more specifically to an oilseed cake protein extraction composition.

### INTRODUCTION

A variety of oils are produced by pressing oilseed cakes until the oil is liberated. While referred to as an “oilseed cake,” such cakes often include beans and/or seeds such as cotton seeds, castor beans and soybeans. Traditionally, the plant matter and pulp remaining after the pressing of the oilseed cake has been discarded as waste, but recently there has been a push to make use of this material to increase sustainability of the practice and also extract additional value from the cake. The pulp and plant matter comprise a variety of beneficial products such as protein, crude fiber, and essential minerals (e.g., calcium, potassium, phosphorous and magnesium) that can be recovered; however, removal of the products is difficult and expensive.

One material particularly prized in oilseed cakes is protein because it may be utilized in fertilizer and feedstocks for animals. Various attempts at extracting the protein from seed oil cakes have been attempted. Typically, a protein extraction of 75% or greater as measured according to Kjeldahl Method is necessary to achieve an economically viable process. Removal of protein from oilseed cakes is economically and technically challenging due to the unique nature of proteins. For example, the macromolecular structure of proteins enables proteins to reversibly transition between folded and unfolded states. Alkaline extraction mediums enable the protein to transition to its unfolded (i.e., denatured) state and more easily be solubilized in the medium and removed from the seed oil cake. Generally, greater protein extractions are achieved through higher pHs (i.e., 13 and above) of the extraction medium. The extraction medium of the protein extraction poses several technical and manufacturing issues. For example, the use of the extraction medium necessitates that a great amount of alkaline material (e.g., caustic soda) is used. Further, the greater amount of alkaline material used in the extraction medium means that a greater amount of remediation must be performed before it can be disposed of. The use of great quantities of alkaline material and the associated remediation processes increase the cost of protein extraction. As such, it would be beneficial to discover a recovery process that can be performed using less alkaline material than traditional processes.

In addition to the pH of the extraction medium, protein extraction from oilseed cakes is dependent on the water to oilseed cake weight ratio of the extraction medium. A water to oilseed cake weight ratio of 10:1 is typically used to achieve sufficient mixing to an increase protein extraction, however such a large water demand results in a more costly and less ecologically friendly recovery process. Accordingly, a protein extraction process that utilizes a water to oilseed cake weight ratio of 10:1 or less while maintaining a protein extraction of 75% or greater would be advantageous.

In view of the foregoing, it would be surprising to discover a composition that achieves a 75% protein extraction or better while simultaneously using less alkaline material than convention protein extractions and utilizes a water to oilseed cake weight ratio of 10:1 or less.

### SUMMARY OF THE DISCLOSURE

The inventor of the present disclosure has discovered a composition that achieves a 75% protein extraction or better while simultaneously using less alkaline material than convention protein extractions and utilizes a water to oilseed cake weight ratio of 10:1 or less has been discovered.

The present disclosure is a result of discovering that the introduction of a surfactant into the extraction medium not only lowers the amount of alkaline material necessary to achieve a 75% or greater protein extraction, but also enables a water to oilseed cake weight ratio of 10:1 or less. Without being bound by theory, it is believed that the introduction of the surfactant into the extraction medium increase the solubility of the protein in the extraction medium. Specifically, the surfactant is believed to form micellular structures which bind with multiple locations of the folded proteins and solubilize the proteins into the extraction medium. By enhancing the solubility of the folded proteins in the extraction medium, both the alkalinity of the extraction medium and the water to oilseed cake weight ratio can be reduced.

According to a first feature of the present disclosure, a protein extraction composition, comprises water, oilseed cake, wherein a weight ratio of the water to oilseed cake is 10:1 or less, an alkali salt, and a surfactant, wherein the surfactant is selected from the group consisting of an ionic surfactant, a non-ionic surfactant, and combinations thereof.

According to a second feature of the present disclosure, the alkali salt is selected from the group consisting of sodium hydroxide, potassium hydroxide, calcium hydroxide, magnesium hydroxide and/or combinations thereof.

According to a third feature of the present disclosure, a pH of the protein extraction composition is from 8 to 12.

According to a fourth feature of the present disclosure, the weight ratio of water to oilseed cake is from 5:1 to less than 10:1.

According to a fifth feature of the present disclosure, the oilseed cake comprises pressed castor beans.

According to a sixth feature of the present disclosure, the surfactant is a non-ionic surfactant.

According to a seventh feature of the present disclosure, the surfactant is an ionic surfactant.

According to an eighth feature of the present disclosure, the protein extraction composition comprises from 0.01 wt % to 1.5 wt % of the surfactant based on the total weight of the protein extraction composition.

According to a ninth feature of the present disclosure, the surfactant comprises one or more of Structures (I)-(III), wherein for Structure (I) the average m value is 5 and the average n value is from 3 to 9, wherein for Structure (II) the average n value is from 1 to 4, and wherein for Structure (III) R₁ and R₂ are each independently selected from H and a C₅-C₂₀ alkyl, further wherein each M⁺ is independently selected from the group consisting of Li, K and Na.

According to a tenth feature of the present disclosure, the surfactant comprises both Structure (I) and Structure (II).

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

As used herein, the term weight percent (“wt %”) designates the percentage by weight a part is of a total weight of an identified whole unless otherwise specified.

As used herein, Chemical Abstract Services registration numbers (“CAS #”) refer to the unique numeric identifier as most recently assigned as of the priority date of this document to a chemical compound by the Chemical Abstracts Service.

### Protein Extraction Composition

The present disclosure is directed to a protein extraction composition (“composition”). The composition comprises water, oilseed cake, an alkali salt, and a surfactant. As explained above, the protein extraction composition is designed to extract residual proteins from the oilseed cake thereby enhancing the recovery of materials from the oilseed cake.

The composition comprises from 70 wt % to 98 wt % water based on the total weight of the composition. For example, the composition may comprise 70 wt % or greater, or 72 wt % or greater, or 74 wt % or greater, or 76 wt % or greater, or 78 wt % or greater, or 80 wt % or greater, or 82 wt % or greater, or 84 wt % or greater, or 86 wt % or greater, or 88 wt % or greater, or 90 wt % or greater, or 92 wt % or greater, or 94 wt % or greater, or 96 wt % or greater, while at the same time, 98 wt % or less, or 96 wt % or less, or 94 wt % or less, or 92 wt % or less, or 90 wt % or less, or 88 wt % or less, or 86 wt % or less, or 84 wt % or less, or 82 wt % or less, or 80 wt % or less, or 78 wt % or less, or 76 wt % or less, or 74 wt % or less, or 72 wt % or less of water based on the total weight of the composition.

The composition has a potential of hydrogen (“pH”) from 8.0 to 13.0 as measured according to ASTM D1293. For example, the composition may have a pH of 8.0 or greater, or 8.2 or greater, 8.4 or greater, or 8.6 or greater, or 8.8 or greater, or 9.0 or greater, or 9.2 or greater, 9.4 or greater, or 9.6 or greater, or 9.8 or greater, or 10.0 or greater, or 10.2 or greater, 10.4 or greater, or 10.6 or greater, or 10.8 or greater, or 11.0 or greater, or 11.2 or greater, 11.4 or greater, or 11.6 or greater, or 11.8 or greater, or 12.0 or greater, or 12.2 or greater, 12.4 or greater, or 12.6 or greater, or 12.8 or greater, while at the same time, 13.0 or less, or 12.8 or less, or 12.6 or less, or 12.4 or less, or 12.2 or less, or 12.0 or less, or 11.8 or less, or 11.6 or less, or 11.4 or less, or 11.2 or less, or 11.0 or less, or 10.8 or less, or 10.6 or less, or 10.4 or less, or 10.2 or less, or 10.0 or less, or 9.8 or less, or 9.6 or less, or 9.4 or less, or 9.2 or less, or 9.0 or less, or 8.8 or less, or 8.6 or less, or 8.4 or less, or 8.2 or less as measured according to ASTM D1293.

### Oilseed Cake

The composition comprises oilseed cake. As used herein, the term “oilseed cake” covers all cakes, pulps, meals and other residual plant matter remaining after a plant material was pressed or otherwise processed for oil extraction. Although using the term “seed,” the oilseed cake includes plant matter from seeds, beans, fruits, husks, plant bodies and other plant-based materials. Exemplary materials that may be used to form the oilseed cakes include soybeans, castor beans, groundnuts, cottonseed, rapeseed, sunflowers and sunflower seeds, oil palm, peanuts, coconut, palm kernel, linseed, sesame seed and others. In a specific example, the oilseed cake comprises pressed castor beans.

The composition can comprise from 1 wt % to 20 wt % water based on the total weight of the composition. For example, the composition may comprise 1 wt % or greater, or 2 wt % or greater, or 4 wt % or greater, or 6 wt % or greater, or 8 wt % or greater, or 10 wt % or greater, or 12 wt % or greater, or 14 wt % or greater, or 16 wt % or greater, or 18 wt % or greater, while at the same time, 20 wt % or less, or 18 wt % or less, or 16 wt % or less, or 14 wt % or less, or 12 wt % or less, or 10 wt % or less, or 8 wt % or less, or 6 wt % or less, or 4 wt % or less, or 2 wt % or less of the oilseed cake based on the total weight of the composition.

The composition may have a weight ratio of the water to oilseed cake of 20:1 or less. For example, the water to oilseed cake weight ratio may be 20:1 or less, or 19:1 or less, or 18:1 or less, or 17:1 or less, or 16:1 or less, or 15:1 or less, or 14:1 or less, or 13:1 or less, or 12:1 or less, or 11:1 or less, or 10:1 or less, or 9:1 or less, or 8:1 or less, or 7:1 or less, or 6:1 or less, or 5:1 or less, or 4:1 or less, or 3:1 or less, or 2:1 or less, or 1:1 or less.

### Alkali Salt

The composition, while extracting the protein, has a generally alkaline pH which is controlled by the addition of an alkali salt. The alkali salt may be selected from the group consisting of sodium hydroxide, potassium hydroxide, calcium hydroxide, magnesium hydroxide and/or combinations thereof. The alkali salt may be added the composition as-is and/or as an aqueous solution.

The composition may comprise from 0.01 wt % or greater, or 0.02 wt % or greater, or 0.04 wt % or greater, or 0.06 wt % or greater, or 0.08 wt % or greater, or 0.10 wt % or greater, or 0.20 wt % or greater, or 0.30 wt % or greater, or 0.40 wt % or greater, or 0.50 wt % or greater, or 0.60 wt % or greater, or 0.70 wt % or greater, or 0.80 wt % or greater, or 0.90 wt % or greater, or 1.00 wt % or greater, or 2.00 wt % or greater, or 3.00 wt % or greater, or 4.00 wt % or greater, while at the same time, 5.00 wt % or less, or 4.00 wt % or less, or 3.00 wt % or less, or 2.00 wt % or less, or 1.00 wt % or less, or 0.50 wt % or less, or 0.10 wt % or less, or 0.05 wt % or less, or 0.02 wt % or less of the alkali salt based on the total weight of the composition.

### Surfactant

The composition utilizes the surfactant to extract the residual protein from the oilseed cake. The surfactant is selected from the group consisting of an ionic surfactant, a non-ionic surfactant, and combinations thereof. In a non-ionic example of the surfactant, the surfactant may comprise Structure (I)

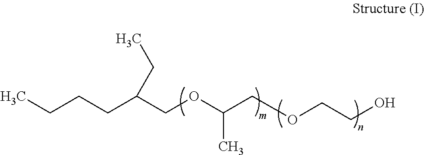

wherein the average m value of Structure (I) can be from 1 to 10 and the average n value can be from 1 to 20. For example, the average m value of Structure (I) may be 1 or greater, or 2 or greater, or 3 or greater, or 4 or greater, or 5 or greater, or 6 or greater, or 7 or greater, or 8 or greater, or 9 or greater, while at the same time, 10 or less, or 9 or less, or 8 or less, or 7 or less, or 6 or less, or 5 or less, or 4 or less, or 3 or less, or 2 or less. The average n value of Structure (I) may be 1 or greater, or 2 or greater, or 3 or greater, or 4 or greater, or 5 or greater, or 6 or greater, or 7 or greater, or 8 or greater, or 9 or greater, or 10 or greater, or 11 or greater, or 12 or greater, or 13 or greater, or 14 or greater, or 15 or greater, or 16 or greater, or 17 or greater, or 18 or greater, or 19 or greater, while at the same time, 20 or less, or 19 or less, or 18 or less, or 17 or less, or 16 or less, or 15 or less, or 14 or less, or 13 or less, or 12 or less, or 11 or less, or 10 or less, or 9 or less, or 8 or less, or 7 or less, or 6 or less, or 5 or less, or 4 or less, or 3 or less, or 2 or less. Any combination of m and n values for Structure (1) may be combined and are hereby disclosed.

In an example of a non-ionic surfactant, the surfactant may be an alkyl polyglucoside. One exemplary polyglucoside is provided in Structure (II)

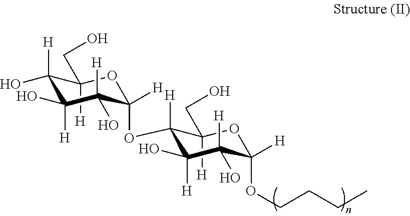

wherein the average n value of Structure (II) is from 1.00 to 4.00. For example, the average n value of Structure (II) may be 1.00 or greater, or 1.25 or greater, or 1.50 or greater, or 1.75 or greater, or 2.00 or greater, or 2.25 or greater, or 2.50 or greater, or 2.75 or greater, or 3.00 or greater, or 3.25 or greater, or 3.50 or greater, or 3.75 or greater, while at the same time, 4.00 or less, or 3.75 or less, or 3.50 or less, or 3.25 or less, or 3.00 or less, or 2.75 or less, or 2.50 or less, or 2.25 or less, or 2.00 or less, or 1.75 or less, or 1.50 or less, or 1.25 or less as measured by C¹³ nuclear magnetic resonance. In other words, the alkyl moiety of Structure (II) may have from 4 to 16 carbons. Specifically, the alkyl moiety of Structure (II) may have 4 carbons or greater, or 5 carbons or greater, or 6 carbons or greater, or 7 carbons or greater, or 8 carbons or greater, or 9 carbons or greater, or 10 carbons or greater, or 11 carbons or greater, or 12 carbons or greater, or 13 carbons or greater, or 14 carbons or greater, or 15 carbons or greater, while at the same time, 16 carbons or less, or 15 carbons or less, or 14 carbons or less, or 13 carbons or less, or 12 carbons or less, or 11 carbons or less, or 10 carbons or less, or 9 carbons or less, or 8 carbons or less, or 7 carbons or less, or 6 carbons or less, or 5 carbons or less as measured according to by C¹³ nuclear magnetic resonance.

In an example of an ionic surfactant, the surfactant may be an alkylated diphenyl oxide disulfonate such as provided in Structure (III)

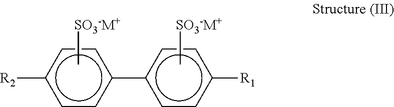

wherein R₁ and R₂ are each independently selected from H and a C₅-C₂₀ alkyl. For example, each of R₁ and R₂ may independently be a C₅ alkyl, or a C₆ alkyl, or a C₇ alkyl, or a C₈ alkyl, or a C₉ alkyl, or a C₁₀ alkyl, or a C₁₁ alkyl, or a C₁₂ alkyl, or a C₁₃ alkyl, or a C₁₄ alkyl, or a C₁₅ alkyl, or a C₁₆ alkyl, or a C₁₇ alkyl, or a C₁₈ alkyl, or a C₁₉ alkyl, or a C₂₀ alkyl. R₁ and R₂ may each independently be a linear or a branched alkyl. Each M⁺ of Structure (III) is independently selected from the group consisting of Li, K and Na. The surfactant may comprise multiple different compounds all adhering to Structure (III) but differing in the selected options of R₁, R₂ and M⁺.

Additionally or alternatively, the surfactant may comprise one or more of a seed alcohol alkoxylate, secondary alcohol ethoxylate, an ethylene oxide and propylene oxide copolymer, and/or a fatty alcohol alkoxylate where the alkyl chain have from 8 to 18 carbon atoms.

The composition may comprise 0.01 wt % to 5 wt % of the surfactant based on the total weight of the composition. The composition may comprise from 0.01 wt % or greater, or 0.02 wt % or greater, or 0.04 wt % or greater, or 0.06 wt % or greater, or 0.08 wt % or greater, or 0.10 wt % or greater, or 0.20 wt % or greater, or 0.30 wt % or greater, or 0.40 wt % or greater, or 0.50 wt % or greater, or 0.60 wt % or greater, or 0.70 wt % or greater, or 0.80 wt % or greater, or 0.90 wt % or greater, or 1.00 wt % or greater, or 2.00 wt % or greater, or 3.00 wt % or greater, or 4.00 wt % or greater, while at the same time, 5.00 wt % or less, or 4.00 wt % or less, or 3.00 wt % or less, or 2.00 wt % or less, or 1.00% or less, or 0.50 wt % or less, or 0.10 wt % or less, 0.05 wt % or less, or 0.02 wt % or less of the surfactant based on the total weight of the composition.

As explained above, the surfactant may comprise one or more of the different types of surfactants. In examples where more than one type of surfactant is present, each surfactant may independently be one of 1 wt % or greater, or 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater, or 95 wt % or greater, or 99 wt % or greater of the total amount of surfactant used in the composition.

### Protein Extraction

The composition is effective at extracting residual proteins from the oilseed cake. The composition may extract 75% or greater, or 80% or greater, or 85% or greater, or 90% or greater, or 95% or greater or 98% or greater of the protein from the oilseed cake as measured according to the Kjeldahl Method.

### EXAMPLES

### Materials

The following materials were used in the examples.

SURF1 is 99 wt % Structure (I) wherein the average m value is 5 and the average n value is from 3 to 9 and is commercially available from The Dow Chemical Company, Midland, Michigan.

SURF2 is 80 wt % sodium laureth-2 sulfate in water having a CAS # of 3088-31-1 and is commercially available from Sigma Aldrich, St. Louis, Missouri.

SURF3 is 46 wt % Structure (III) in water, wherein each M⁺ is Na, R₁ is H, and R₂ is a C₁₆ linear alkyl. SURF3 is available from The Dow Chemical Company, Midland, Michigan.

SURF4 is 50 wt % Structure (II) having an average n value of 2 to 2.5 in water and is available from The Dow Chemical Company, Midland, Michigan.

OSC is castor meal in a powder form of which 100% is 500 micron or smaller in diameter and is commercially available from Jayant Agro-Organics Limited, Mumbai, India.

NaOH is sodium hydroxide solution and is commercially available from Sigma Aldrich, St. Louis, Missouri.

### Sample Preparation

The samples were prepared by placing the designated amount of OSC and deionized water in a container and stirred using an overhead stirrer at 500 revolutions per minute for 10 minutes. Next, the samples had the indicated amount of a 25 wt % NaOH aqueous solution added after stirring. Next, the indicated surfactant was added to the sample at the indicated dosage and stirred using an overhead stirrer at 500 revolutions per minute for 90 minutes. Finally, the supernatant solution was poured off and the protein content was measured according to ASTM D3590. Three samples of each example were prepared.

### Test Methods

Kjeldahl Method: First, the total nitrogen content of the supernatant is determined in accordance with ASTM D3590. Next, the nitrogen content, in units of percent, is multiplied by a protein factor of 6.25 to determine a final protein content extracted in units of percent.

Potential of hydrogen: measured according to ASTM D1293.

### Results

Tables 1-3 provide the results of various comparative examples (“CE”) and inventive examples (“JE”). Table 1 provides the results for examples utilizing 10 grams of water mixed with 10 grams of OSC and the other listed components. The initial pH is before the addition of the 25 wt % NaOH aqueous solution and the final pH is the pH after the NaOH addition.

TABLE 1

| | NaOH | | | Quantity of | | |
|---|---|---|---|---|---|---|
| | solution | Initial | | Supernatant | Protein | % protein |
| | (g) | pH | Final pH | (g) | wt (g) | extract |
| CE1 | 0.222 | 6.12 | 11.55 | 56.82 | 1.19 | 38.38 ± 1.2 |
| CE2 | 0.444 | 6.13 | 12.61 | 50.88 | 1.586 | 51.16 ± 1.8 |
| CE3 | 0.666 | 6.14 | 12.78 | 56.71 | 2.3084 | 74.46 ± 1.2 |
| CE4 | 1.11 | 6.1 | 14 | 53.71 | 2.86 | 92.25 ± 1.6 |

As can be seen from Table 1, an increasing amount of NaOH is needed in order to increase the protein extraction from the OSC. Table 1 serves to set a baseline for the amount of NaOH necessary to achieve certain protein extractions when no surfactant is used.

Table 2 provides the results of examples utilizing a surfactant at the same water to OSC ratio as the comparative examples of Table 1.

TABLE 2

| | Example | | | | | |
|---|---|---|---|---|---|---|
| | CE5 | IE1 | IE2 | IE3 | IE4 | IE5 |
| | Surfactant | | | | | |
| | | | | SURF3:SURF1 | | |
| | | | | (80:20 weight | | |
| | None | SURF1 | SURF2 | ratio) | SURF4 | SURF4 |
| OSC (g) | 10 | 10 | 10 | 10 | 10 | 10 |
| Water (g) | 100 | 100 | 100 | 100 | 100 | 100 |
| Initial pH | 6.1 | 6.1 | 6.1 | 6.1 | 6.1 | 8.2 |
| NaOH | 2.21 | 1.33 | 1.34 | 0.1665 | 0.88 | 0.02 |
| solution (g) | | | | | | |
| Final pH | 12 | 12 | 12 | 10.87 | 12 | 12 |
| Surfactant (g) | 0 | 0.5 | 0.5 | 0.5 | 0.5 | 1 |
| Protein (g) | 2.3025 | 2.56 | 2.4375 | 3.0363 | 2.375 | 2.625 |
| Protein | 74.28 ± 1.5 | 82.58 ± 1.7 | 78.69 ± 1.3 | 97.94 ± 2.3 | 76.69 ± 1.9 | 84.69 ± 2.0 |
| extraction (%) | | | | | | |

IE1-IE5 of Table 2 demonstrate that the addition of surfactant enhanced the protein extraction with less NaOH used as compared to CE5 without surfactant. The addition of a blend of surfactants in IE3 increased the protein extraction content at lower pH of about 11 when compared to extraction with no surfactant at pH 11-13. The addition of both anionic and non-ionic surfactants in IE1-IE5 enhanced protein extraction at lower NaOH concentrations as compared to CE5.

Table 3 provides examples testing the effect of water to oilseed cake weight ratio on the ultimate percent of protein extraction.

TABLE 3

| | | | SURF3:SURF1 | NaOH | | | |
|---|---|---|---|---|---|---|---|
| | Water:OSC | Initial | (80:20 weight | solution | Final | Protein | % protein |
| Ex | weight ratio | pH | ratio) | (g) | pH | (g) | extract |
| CE4 | 10:1 | 6 | 0 | 2.21 | 14 | 2.86 | 92.25 ± 1.8 |
| CE6 | 7:1 | 6 | 0 | 2.3 | 12 | 1.611 | 51.96 ± 2.2 |
| IE3 | 10:1 | 6.1 | 0.5 | 0.1665 | 10.87 | 3.0363 | 97.94 ± 2.3 |
| IE6 | 7:1 | 6.33 | 0.5 | 0.1665 | 10.82 | 2.6521 | 85.55 ± 1.8 |

With respect to CE4 and CE6, when the water content was decreased in the composition from a water to OSC weight ratio of 10:1 to 7:1, the protein content decreased from approximately 92% to approximately 52% representing a 40% decrease in protein extraction. Surprisingly though, the introduction of the surfactant to the composition as shown in IE3 and IE6 prevents the steep decrease in protein extraction seen in CE4 and CE6. As such, use of the identified surfactants in the composition achieves a 75% protein extraction or better while simultaneously using less alkaline material than convention protein extractions and utilizes a water to oilseed cake weight ratio of 10:1 or less.

1. A protein extraction composition, comprising:
water;
oilseed cake, wherein a weight ratio of the water to oilseed cake is 10:1 or less;
an alkali salt; and
a surfactant, wherein the surfactant is selected from one or more from the group consisting of Structures (I)-(III): 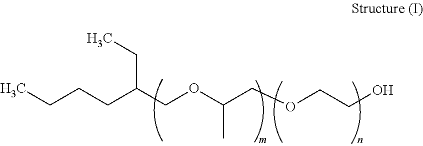
wherein for Structure (I) the average m value is 5 and the average n value is from 3 to 9, 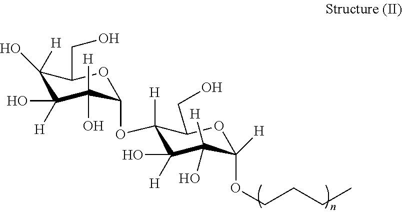
wherein for Structure (II) the average n value is from 1 to 4, and 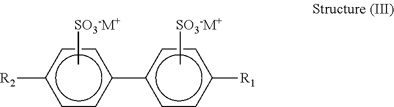
wherein for Structure (III) R₁ and R₂ are each independently selected from H and a C₅-C₂₀ alkyl, further wherein each M⁺ is independently selected from the group consisting of Li, K and Na.

2. The protein extraction composition of claim 1, wherein the alkali salt is selected from the group consisting of sodium hydroxide, potassium hydroxide, calcium hydroxide, magnesium hydroxide and/or combinations thereof.

3. The protein extraction composition of claim 1, wherein a pH of the protein extraction composition is from 8 to 12.

4. The protein extraction composition of claim 1, wherein the weight ratio of water to oilseed cake is from 5:1 to less than 10:1.

5. The protein extraction composition of claim 1, wherein the oilseed cake comprises pressed castor beans.

6. (canceled)

7. (canceled)

8. The protein extraction composition of claim 1, wherein the protein extraction composition comprises from 0.01 wt % to 1.5 wt % of the surfactant based on the total weight of the protein extraction composition.

9. (canceled)

10. The protein extraction composition of claim 1, wherein the surfactant comprises both Structure (I) and Structure (II).
